(19) United States
(12) Patent Application Publication
(10) Pub. No.: US 2016/0323984 A1
(43) Pub. Date: Nov. 3, 2016

(54) DISCHARGE LAMP LIGHTING APPARATUS

(71) Applicant: USHIO DENKI KABUSHIKI KAISHA, Tokyo (JP)

(72) Inventors: Tomohiro OKUDA, Himeji-shi (JP); Minoru FUKUDA, Himeji-shi (JP)

(73) Assignee: USHIO DENKI KABUSHIKI KAISHA, Tokyo (JP)

(21) Appl. No.: 15/105,742

(22) PCT Filed: Sep. 19, 2014
(86) PCT No.: PCT/JP2014/074790

§ 371 Date: Jun. 17, 2016

(30) Foreign Application Priority Data
Dec. 17, 2013 (JP) 2013-260591

(51) Int. Cl. H05B 41/39; H01J 61/073; H01J 61/30; H01J 61/82; H05B 41/288; G03B 21/20

(52) U.S. Cl. CPC H05B 41/39; H05B 41/2887; G03B 21/2053; H01J 61/302; H01J 61/822; H01J 61/0732

(57) ABSTRACT

A lighting apparatus of a discharge lamp is provided with a power supply section which supplies AC current to the discharge lamp, a power control section which outputs a signal concerning a control power value to the power supply section, and a pulse generating section which outputs a pulse wave to the power supply section. The power control section carries out a control of differentiating the control power value at a first period and the control power value at a second period, in a direction that a difference is reduced between average light intensities or average powers of the discharge lamp at the first period and the second period, in comparison with a case where the control power value is identical at the first period and the second period.

### TECHNICAL FIELD

The present invention relates to a lighting apparatus of a discharge lamp which is preferably used for a light source of a projector, and the like.

### BACKGROUND ART

A discharge lamp having a high mercury vapor pressure is used for a light source of a projector device. The high-pressure mercury lamp can obtain light having a visible wavelength band with a high output by making the mercury vapor pressure higher.

The discharge lamp has an approximately spherical light emitting section which is formed by a discharge vessel, and a pair of electrodes are arranged in the light emitting section in such a manner as to face each other at an extremely small distance, for example, 2 mm or less.

In the case where the discharge lamp as mentioned above is turned on in the same state over the long term, a plurality of micro projections may be formed due to high temperature, or micro irregularities may be generated on a surface section of a leading end of the electrode. The micro projections or the irregularities are generated by melting of a material (for example, tungsten) constructing the electrode, or aggregation of a chemical compound which is created by combination with gas encapsulated within the light emitting section, and existence thereof changes a shape of the surface portion in the leading end of the electrode. A starting point of arc moves as the shape changes, and a discharge position is unstable, so that there has been a problem that flickering of the projected light called as flicker is generated.

In order to solve the problem mentioned above, the following patent document 1 discloses a lighting method of a discharge lamp which supplies electric current having a pulse wave P1 with a predetermined frequency (a fundamental frequency) to a discharge lamp, and intermittently or periodically inserting electric current having a pulse wave P2 with a frequency lower than the fundamental frequency to the pulse wave with the fundamental frequency (refer to FIG. 8).

With the frequency of the pulse wave being set to the low frequency, a period for which one electrode is fixed to an anode and the other electrode is fixed to a cathode, that is, a period for which the high voltage is applied between both the electrodes is elongated. As a result, a degree of heating applied to the electrode is enhanced, and the heat can be transferred not only to the leading end of the electrode but also to the position which is away from the leading end. Therefore, while the pulse wave with the low frequency is applied, the heat can be transferred to the position which is away from the leading end of the electrode in addition to the leading end, and the micro projections or the irregularities generated at the position can be melted and vaporized. Accordingly, it is possible to eliminate the projections and the irregularities in the other positions than the leading end portion of the electrode which may adversely affect, and it is possible to stabilize a luminescent spot of the arc.

### PRIOR ART DOCUMENTS

### Patent Documents

Patent Document 1: JP-A-2006-59790

### SUMMARY OF THE INVENTION

### Problems to be Solved by the Invention

The inventors of the present invention have devoted themselves to make a study, and have found that there is seen a phenomenon that a difference is generated in a light intensity of the discharge lamp between a lighting period (a period T1 in FIG. 8) based on the pulse wave P1 with the fundamental frequency and a lighting period (a period T2 in FIG. 8) based on the pulse wave P2 with the lower frequency, in the case where the discharge lamp is lighted according to the method described in the patent document 1 mentioned above. The reason why the phenomenon mentioned above is generated is thought to be due to the following reasons.

In the period T1, since the electric current is supplied to the discharge lamp on the basis of the pulse wave P1 with the high frequency, the polarity reversion of the supplied current is frequently generated. Since the current value comes to zero value in a moment at a timing at which the polarity of the supplied current is reversed, the output of the projected light is lowered in a moment at this timing (a dip phenomenon). On the contrary, in the period T2, since the electric current is supplied to the discharge lamp on the basis of the pulse wave P2 with the low frequency, and the polarity of the supplied current is hardly reversed, the output reduction of the projected light is hardly generated. As a result, it is thought that the light intensity is lowered at the period T1 due to the instantaneous reduction of the projected light caused by the difference in the polarity reversion than at the period T2.

FIG. 9 is an example of a graph showing a variation in the light intensity of the projected light in conformity to a waveform of the lamp current shown in FIG. 8 under the above consideration. In FIG. 9, (a) shows the waveform of the same lamp current as FIG. 8, and (b) shows the waveform exhibiting the variation in the light intensity of the projected light. Within a range shown in FIG. 9(b), a state D1 in which the light intensity is lowered is frequently generated within the period T1; however, a state D2 in which the light intensity is lowered is generated only one time within the period T2.

According to FIG. 9, since the dip phenomenon is frequently generated within the period T1, the frequency at which the light intensity is lowered in a moment is high. Since the phenomenon is generated at an extremely short cycle, the phenomenon that the instantaneous reduction of the light intensity is generated plurality of times is not viewed, but a state in which the light intensity is lowered at a certain degree over a whole period T1 is viewed. On the contrary, since the frequency at which the dip phenomenon is generated is generated is extremely low within the period T2, in comparison with the period T1, the reduction of the light intensity over a whole period T2 is hardly generated.

The discharge lamp is driven to be lighted on the basis of the pulse wave P1 with the fundamental frequency at a lot of periods, and is driven to be lighted on the basis of the pulse wave P2 with the low frequency intermittently or periodically. More specifically, this is an aspect that the period corresponding to the period T1 is long, and the period corresponding to the period T2 is intermittently or periodically inserted under driving. As a result, the light intensity is viewed so as to rise in a moment at the timing when the pulse wave P2 with the low frequency is inserted, and it is thought that this appears as the light intensity difference mentioned above. Particularly, in the case where the pulse wave P2 with the low frequency is periodically inserted, the light intensity periodically rises. As a result, a problem that the projected light blinks is thought to be generated.

Further, in the case where the discharge lamp is driven by the driving method as mentioned above, the above phenomenon that the light intensity at the period T2 becomes higher than the light intensity at the period T1 is not always generated. In some specification of an electric power unit or a program, a phenomenon that the light intensity at the period T2 becomes lower than the light intensity at the period T1 is thought to be generated. This can be thought to be caused by an overshoot when driving with AC current is performed.

FIG. 10 schematically describes an example of a current waveform at the period T1. As mentioned above, the polarity of the supplied current is reversed with the high frequency at the period T1. It is necessary to raise the current value in a moment for a short time at a timing at which the polarity is reversed from a negative polarity to a positive polarity; however, the current value comes to a current value which is higher than a target value (a steady state value) in a moment just before the current value reaches the steady state value, and thereafter lowers a little so as to realize the steady state value (sign Y1 in FIG. 10). The inverse phenomenon is generated at a timing when the polarity is reversed from the positive polarity to the negative polarity (sign Y2 in FIG. 10). The overshoot as mentioned above is a phenomenon which is generated by reversing the polarity for the extremely short time, and a magnitude thereof depends on the structure of the electric power unit or the program.

In the case where the overshoot (Y1, Y2) is taken into consideration, the electric current which is greater than the target steady state value is actually supplied. Therefore, the light intensity rises a little in this moment. The number of times of reversing the polarity is extremely higher in the period T1 than in the period T2. As a result, the frequency at which the greater electric current than the target steady state value is supplied becomes extremely higher in the period T1 than in the period T2. Since the phenomenon that the amount of electric current rises is generated during the extremely short time as mentioned above, the rising of the instantaneous light intensity caused by the phenomenon itself is not viewed. However, since an average amount of electric current supplied over the whole period T1 is increased in comparison with an average amount of electric current supplied over the whole period T2, the light intensity at the period T1 is viewed more frequently than the light intensity at the period T2. More specifically, if the phenomenon mentioned above is generated, the light intensity is periodically lowered in the case where the pulse wave with the low frequency is periodically inserted. As a result, the problem that the projected light blinks is thought to be generated.

In the case where the discharge lamp is driven according to the method described in the patent document 1 as mentioned above, the light intensity is different between the period T1 and the period T2, and may be viewed as the flickering. Further, in some structure of the electric power unit or the program, the possibility that the light intensity rises may be lowered at the period T2 of being intermittently or periodically inserted.

The present invention is made by taking the problems mentioned above into consideration, and an object of the present invention is to provide a lighting apparatus which can suppress flickering (flicker) of light output from a discharge lamp in comparison with the conventional apparatus.

### Means for Solving the Problems

A lighting apparatus of a discharge lamp according to the present invention includes:

a power supply section which supplies AC current to the discharge lamp in which a pair of electrodes are arranged so as to face each other in a discharge vessel in which predetermined gas is encapsulated;

a power control section which outputs a signal concerning a control power value to the power supply section; and

a pulse generating section which outputs a pulse wave to the power supply section.

Further, the power supply section is structured to convert supplied DC voltage into AC current in response to a frequency of the pulse wave and the control power value so as to supply the converted AC current to the discharge lamp,

the pulse generation section is structured to repeat a cycle of outputting a first pulse wave over a first period and thereafter outputting a second pulse wave having a frequency lower than the first pulse wave over a second period shorter than the first period, and

the power control section carries out a control of differentiating the control power value at the first period and the control power value at the second period, in a direction that a difference is reduced between an average light intensity of the discharge lamp at the first period and an average light intensity of the discharge lamp at the second period, or a direction that a difference is reduced between an average power supplied to the discharge lamp at the first period and an average power supplied to the discharge lamp at the second period, in comparison with the case where the control power value is identical at the first period and the second period.

Conventionally, control has been performed such that the identical electric power is supplied to the discharge lamp from the power supply section over both the first period when the lighting is driven on the basis of the pulse wave with the high frequency and the second period when the lighting is driven on the basis of the pulse wave with the low frequency. This is a control that the input power is fixed at the instantaneous time point within each of the periods. However, in the case where such control is carried out, the frequency that the polarity reversion is generated is different between the first period and the second period, thereby possibly generating the difference in the light intensity in each of the period as mentioned above in the item “Problem to be Solved by the Invention”.

The above problem is thought to be caused by the matter that the average input power is not fixed in the case where each of the period is seen as a whole, due to the difference in frequency of the polarity reversion, even if a constant power control is carried out in a moment at each of the periods. As a result, the difference is generated between the average value of the light intensity within the first period and the average value of the light intensity within the second period, and the flicker is viewed. Particularly, in the case where the electric power is supplied to the discharge lamp from the power supply section on the basis of the first pulse wave reversing the polarity with an extremely high frequency, for example, about 60 to 1000 Hz, at the first period, the timing in the polarity reversion of the supplied current is generated at an extremely short time interval, and fluctuation of the supplied power in connection therewith is generated within an extremely short time. As a result, the light intensity output from the discharge lamp is viewed as the light intensity when the average power calculated by taking into consideration increasing and decreasing from the steady state value in connection with the power fluctuation is continuously supplied, within the first period, before starting the next second period just after end of the proximate second period.

The light intensity output from the discharge lamp is viewed as the light intensity when the average power supplied within the second period is continuously supplied, in the same manner within the second period, before starting the next first period just after end of the proximate first period. However, the frequency that the polarity reversion is generated is lower than the proximate first period. Therefore, even if the control is carried out so that the supplied power is equal between the first period and the second period at each of the instantaneous timings, a difference is generated in the supplied average power at the second period than at the proximate first period, due to the difference in the frequency of the polarity reversion. The difference in the average power is viewed as the flicker.

The lighting apparatus of the discharge lamp according to the present invention intentionally differentiates the value of power supplied to the discharge lamp from the power supply section between the first period that the discharge lamp is driven by the first pulse wave with the higher frequency, and the second period that the discharge lamp is driven by the second pulse wave with the lower frequency, on the basis of the control from the power control section. In more detail, the value of power is differentiated between the first period and the second period in the direction that the difference in the average light intensities at the respective periods is reduced, and the direction that the difference in the average powers at the respective periods is reduced, in comparison with the case where the value of the power supplied to the discharge lamp from the power supply section is equalized over both the periods of the first period and the second period. As a result, the difference in the light intensities is reduced between the first period and the second period as mentioned above, and the flicker is suppressed.

Further, according to the method mentioned above, the effect of suppressing the flicker can be realized in both the case where the light intensity at the second period is viewed higher in comparison with the first period and the case where it is viewed lower.

Further, in the above structure, the power control section may be structured to perform control to differentiate the control power value at the first period and the control power value at the second period, so that the difference between the average light intensity of the discharge lamp at the first period and the average light intensity of the discharge lamp at the second period is within a range of ±2%, or the difference between the average power supplied to the discharge lamp at the first period and the average power supplied to the discharge lamp at the second period is within a range of ±2%, in comparison with the case where the same control power value is set in both of the first period and the second period.

As mentioned later in an item “Mode for Carrying Out the Invention”, in the case where the difference in the average light intensity between the first period and the second period or the difference in the average power between both the periods is suppressed within ±2%, it is possible to make the possibility that the flicker is viewed extremely low.

Further, in the above structure, the power control section may be structured to previously store information concerning a ratio between the control power value at the first period and the control power value at the second period and to perform control to differentiate the control power value at the first period and the control power value at the second period, on the basis of the stored information.

In a preliminary stage of shipping the lighting apparatus and the discharge lamp, the average light intensity or the average power can be measured at each of the periods when the control power value is fixed previously between the first period and the second period, and the ratio of the input powers at the respective periods can be decided for reducing the difference between the both on the basis of the results and can be stored in the control power value. The power control section outputs the control power value based on the stored information to the power supply section at each of the first period and the second period, and the power supply section supplies the input power decided based on the value to the discharge lamp. As a result, the differences in the supplied average powers and the average light intensities at the first period and the second period are reduced, and the viewing of the flicker is suppressed.

### Effect of the Invention

According to the lighting apparatus of the present invention, it is possible to suppress the flickering (the flicker) of the light output from the discharge lamp in comparison with the conventional apparatus.

### BRIEF DESCRIPTION OF THE DRAWINGS

FIG. 1A is a schematic view of a cross section of a discharge lamp.

FIG. 1B is a schematic view of a cross section obtained by enlarging the discharge lamp near a leading end of an electrode.

FIG. 2 is a circuit block diagram schematically showing a structure of a discharge lamp lighting apparatus.

FIG. 3 is a view showing an example of a waveform of a lamp current which is supplied form the discharge lamp lighting apparatus.

FIG. 4 is a view showing an example of the waveform of the lamp current and a waveform of a light intensity.

FIG. 5 is a schematic diagram describing a method of setting a control power value.

FIG. 6 is a graph showing a relationship between a light intensity difference and a flicker level.

FIG. 7 is a view showing the other example of the waveform of the lamp current and the waveform of the light intensity.

FIG. 8 is a view showing an example of a waveform of a conventional lamp current.

FIG. 9 is a view showing an example of the waveform of the conventional lamp current and a waveform of a conventional light intensity.

FIG. 10 is a view showing an example of a part of the waveform of the conventional lamp current.

### MODE FOR CARRYING OUT THE INVENTION

A description will be given of an embodiment of a discharge lamp lighting apparatus according to the present invention with reference to the accompanying drawings. In advance of the description concerning a structure of the lighting apparatus, a description will be given of a structure of a discharge lamp to which AC current is supplied by the lighting apparatus, with reference to the accompanying drawings. In each of the drawings, a dimensional ratio of the drawings does not always coincide with an actual dimensional ratio.

### Structure of Lamp

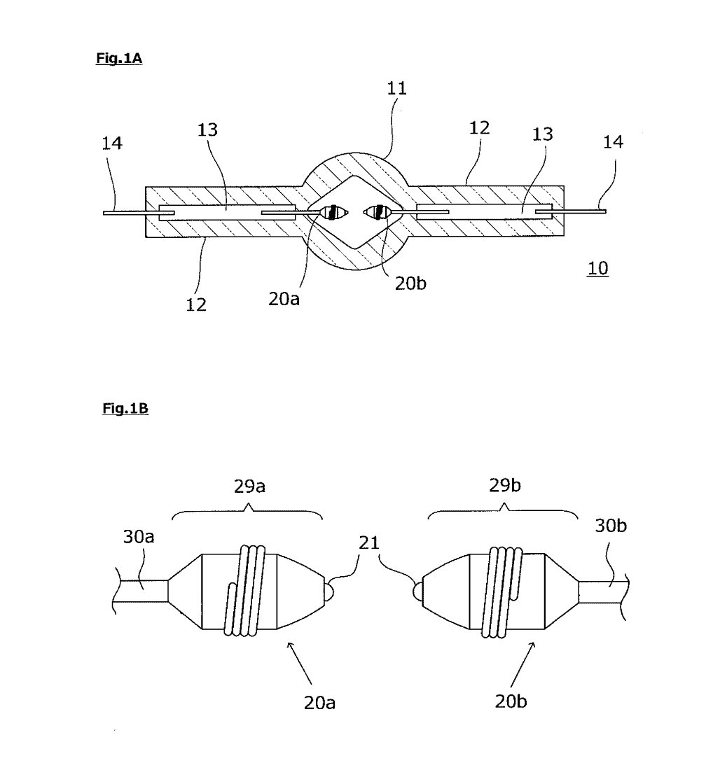

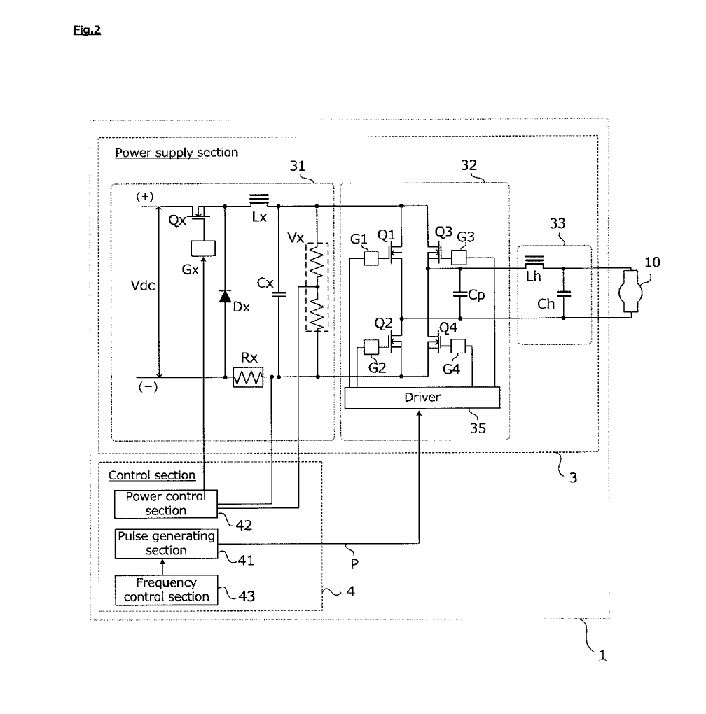

Schematic views of a cross section of the discharge lamp are shown in FIGS. 1A and 1B. FIG. 1B is a schematic view of the cross section obtained by enlarging a leading end of an electrode in FIG. 1A.

A discharge lamp 10 has an approximately spherical light emitting section 11 which is formed by a discharge vessel made of quartz glass. The material of the discharge vessel is not limited to the quartz glass, but the discharge vessel may include the other materials.

A pair of electrodes 20a and 20b are arranged in the light emitting section 11 so as to face each other at an extremely small distance, for example, 2 mm or less.

Further, sealing sections 12 are formed in both end portions of the light emitting section 11. A conducting metal foil 13 including molybdenum is buried in an airtight manner in the sealing section 12, for example, by a shrink seal. Shaft sections of electrodes 20a and 20b are bonded to one ends of the metal foils 13, outer leads 14 are bonded to the other ends of the metal foils 13, and electric power is supplied from the discharge lamp lighting apparatus according to the present invention mentioned later.

Mercury, noble gas and halogen gas are encapsulated in the light emitting section 11 of the discharge lamp 10.

The mercury is provided for obtaining radiated light with a necessary visible wavelength, for example, a wavelength between 360 and 780 nm, and is encapsulated at 0.20 mg/mm³, concretely. The encapsulating amount is differentiated by a temperature condition, and realizes high vapor pressure such as 200 atmospheres or higher as pressure in an inner section of the light emitting section at the lighting time. Further, it is possible to produce a discharge lamp having high mercury vapor pressure of 250 atmospheres or higher or 300 atmospheres or higher at the lighting time, by encapsulating the mercury more. As the mercury vapor pressure increases, the light source more suitable for the projector can be achieved.

For example, argon gas is encapsulated as the noble gas at about 13 kPa. A function thereof is to improve a starting performance for lighting.

Further, iodine, bromine or chlorine is encapsulated as halogen gas in a chemical compound mode with the mercury or the other metals. An encapsulating amount of the halogen is selected from a range between 10⁻⁶ μmol/mm³ and 10⁻² μmol/mm³. The greatest reason for encapsulating the halogen is to make a service life of the discharge lamp utilizing a so-called halogen cycle longer. Further, in the case where the discharge lamp 10 is made extremely compact and is set to an extremely high lighting vapor pressure, it is also possible to obtain an action of preventing devitrification of the discharge vessel by encapsulating the halogen. The devitrification means that the crystallization makes progress from a metastable glass state and changes to an aggregation of the crystal grain which is grown from a lot of crystal nucleuses. If such phenomenon is generated, the light is scattered by the crystal grain boundary and the discharge vessel becomes opaque.

As long as the same function can be realized, the gas encapsulated in the light emitting section 11 is not limited to the gas mentioned above.

As one example, the discharge lamp 10 may be structured such that the maximum outer diameter of the light emitting section is 9.4 mm, a distance between the electrodes is 1.0 mm, the discharge vessel internal volume is 55 mm³, the rated voltage is 70 V, the rated power is 180 W, and the electric power is supplied with an AC system.

Further, on the assumption that the discharge lamp 10 is used by being embedded in the projection which has been made progress of being made compact in recent years, the discharge lamp 10 is required to be extremely downsized in its whole dimension, and a higher amount of light emission is required on the other hand. As a result, the thermal influence within the light emitting section is extremely severe, and a tube wall load value of the lamp is between 0.8 and 2.5 W/mm², specifically 2.4 W/mm². As mentioned above, in the case where the discharge lamp 10 having the higher mercury vapor pressure and tube wall load value is mounted to equipment for presentation such as a projector or an overhead projector, the radiated light having good color rendering properties can be provided for the equipment for presentation.

### Shape of Leading End of Electrode

As shown in FIG. 1B, the electrode 20a includes a head section 29a and a shaft section 30a, and the electrode 20b includes a head section 29b and a shaft section 30b. Further, a projection 21 is formed in a leading end of each of the electrode 20a and the electrode 20b. The projection 21 is formed by aggregation of an electrode material which is fused in the leading end of the electrode at the lamp lighting time. In the present embodiment, a description will be given on the assumption that both of the electrode 20a and the electrode 20b include tungsten; however, the material is not limited to this.

When the electrode 20a and the electrode 20b are energized, they become incandescent to a high temperature, and the tungsten constituting them is sublimated. The sublimated tungsten is combined with the encapsulated halogen gas in an inner wall surface area of the light emitting section 11 which is a comparatively low temperature section, and a halogenated tungsten is formed. Since the halogenated tungsten is comparatively higher in its vapor pressure, the halogenated tungsten is again moved near to the leading ends of the electrode 20a and the electrode 20b in a gas state. Further, when the halogenated tungsten is reheated at this position, the halogenated tungsten is separated into the halogen and the tungsten. Among them, the tungsten is returned to the leading ends of the electrode 20a and the electrode 20b so as to be aggregated, and the halogen is returned as the halogen gas within the light emitting section 11. This corresponds to “halogen cycle” mentioned above. The projection 21 is formed by attachment of the aggregated tungsten to the vicinity of the leading ends of the electrode 20a and the electrode 20b.

### Structure of Lighting Apparatus

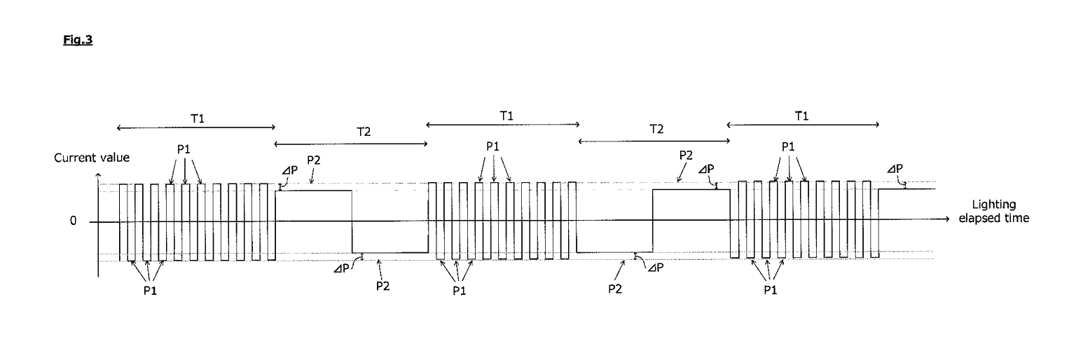

FIG. 2 is a circuit block diagram schematically showing a structure of a discharge lamp lighting apparatus according to the present invention. As shown in FIG. 2, a lighting apparatus 1 is structured to include a power supply section 3 and a control section 4. The control section 4 is provided with a pulse generating section 41, a power control section 42, and a frequency control section 43, and a pulse wave P having a frequency which is determined on the basis of a signal from the frequency control section 43 is supplied to the power supply section 3 from the pulse generating section 41. Further, the power supply section 3 generates an AC current on the basis of a signal (corresponding to a gate signal Gx in FIG. 2) relating to the control power value output from the power control section 42, and the pulse wave P which is output from the pulse generating section 41, and supplies the AC current to the discharge lamp 10. The discharge lamp 10 is lighted by the supply of the AC current.

### <Power Supply Section 3>

The power supply section 3 is provided with a step-down chopper section 31, a DC/AC conversion section 32 and a starter section 33.

The step-down chopper section 31 steps down a DC voltage Vdc to be supplied, to a desired low voltage, and outputs the DC voltage Vdc having a desired low voltage to the DC/AC conversion section 32 in the subsequent stage. In FIG. 2, the step-down chopper section 31 is illustrated as a step-down chopper having a switching element Qx, a reactor Lx, a diode Dx, a smoothening capacitor Cx, a resistance Rx and a voltage dividing resistance Vx, as a specific construction example.

The switching element Qx has one end connected to a positive side power terminal to which the DC voltage Vdc is supplied, and has the other end connected to one end of the reactor Lx. The diode Dx is structured such that a cathode terminal is connected to a connecting point of the switching element Qx and the reactor Lx, and an anode terminal is connected to a negative side power terminal. The smoothing capacitor Cx has one end (positive side terminal) connected to an output side terminal of the reactor Lx, and has the other end (negative side terminal) connected to an output side terminal of the resistance Rx. The resistance Rx is connected between the negative side terminal of the smoothing capacitor Cx and the anode terminal of the diode Dx, and realizes a function of detecting electric current. Further, the voltage dividing resistance Vx is connected between the negative side terminal and the positive side terminal of the smoothing capacitor Cx, and realizes a function of detecting electric voltage.

The switching element Qx is driven by a gate signal Gx which the power control section 42 outputs. On the basis of a duty of the gate signal Gx, the step-down chopper section 31 steps down the input DC voltage Vdc to the electric voltage corresponding to the duty and outputs it to the DC/AC conversion section 32 in the subsequent stage.

The DC/AC conversion section 32 converts the input DC voltage to the AC voltage having a desired frequency, and outputs the AC voltage having a desired frequency to the starter section 33 in the subsequent stage. In FIG. 2, the DC/AC conversion section 32 including the switching elements Q1 to Q4 which are connected like a bridge is shown as a specific construction example (a full bridge circuit).

The switching element Q1 is driven by a gate signal G1 which is output from the driver 35. In the same manner, the switching element Q2 is driven by a gate signal G2, the switching element Q3 is driven by a gate signal G3, and the switching element Q4 is driven by a gate signal G4. The driver 35 outputs the gate signal to a group of the switching elements Q1 and Q4 arranged diagonally, and a group of the switching elements Q2 and Q3 so as to alternately repeat ON and OFF. As a result, the AC voltage having a rectangular waveform is generated between a connecting point of the switching elements Q1 and Q2, and a connecting point of the switching elements Q3 and Q4.

The starter section 33 is the circuit section for boosting the AC voltage supplied from the DC/AC section 32 at the discharge lamp starting time and supplying the boosted AC voltage to the discharge lamp 10. In FIG. 2, the starter section 33 including a coil Lh and a capacitor Ch is shown as a specific construction example. The high electric voltage necessary for starting the discharge lamp is created in a secondary side of the starter section 33 by applying the AC voltage having a high switching frequency (for example, several hundred kHz) near a resonance frequency of an LC series circuit including a coil Lh and a capacitor Ch from the DC/AC section 32 at the discharge lamp starting time, and is supplied to the discharge lamp 10. After the discharge lamp is lighted, a steady-state lighting motion is carried out by transferring the frequency of the AC voltage supplied from the DC/AC section 32 to a steady-state frequency (for example, 60 to 1000 Hz). The steady-state frequency corresponds to a frequency having a pulse wave P1 mentioned later.

In the circuit, the frequency change in the AC voltage to be supplied to the starter section 33 can be achieved by regulating a cycle of switching the On and OFF of the group of the switching elements Q1 and Q4 and the group of the switching elements Q2 and Q3 in the DC/AC section 32. Further, the change of a crest value in the AC voltage to be supplied to the starter section 33 can be achieved by regulating an action duty of the switching element Qx in the step-down chopper section 31.

More specifically, the switching element Qx of the step-down chopper section 31 is turned on and off on the basis of the switching frequency in response to the duty of the gate signal Gx output by the power control section 42, whereby the electric power to be supplied to the discharge lamp 10 is changed. For example, in the case where the power to be supplied to the discharge lamp 10 is intended to be raised, the power control section 42 carries out a control for raising the duty of the gate signal Gx so as to achieve a desired power value.

### <Control Section 4>

As mentioned above, the control section 4 is provided with the pulse generating section 41, the power control section 42 and the frequency control section 43. The pulse generating section 41 outputs the generated pulse signal P to the driver 35 of the DC/AC section 32. As mentioned above, the switching control is applied to the switching elements Q1 to Q4 of the DC/AC section 32 on the basis of the pulse signal.

The pulse generating section 41 creates the pulse signal having the frequency which is designated by the frequency control section 43. The frequency control section 43 may include a micro-computer together with the power control section 42 mentioned above.

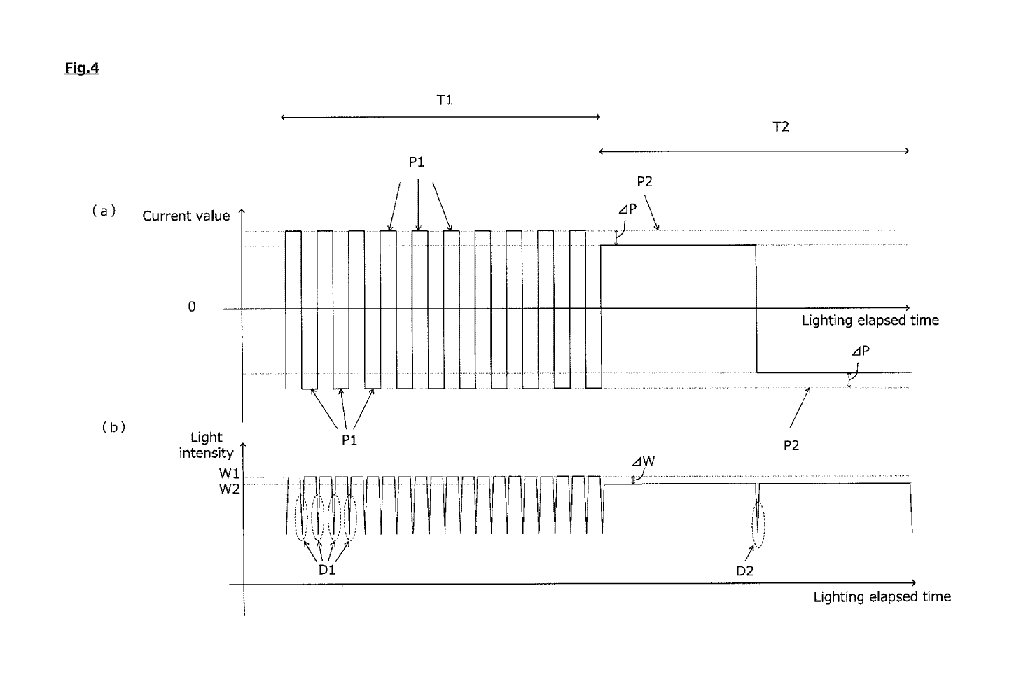

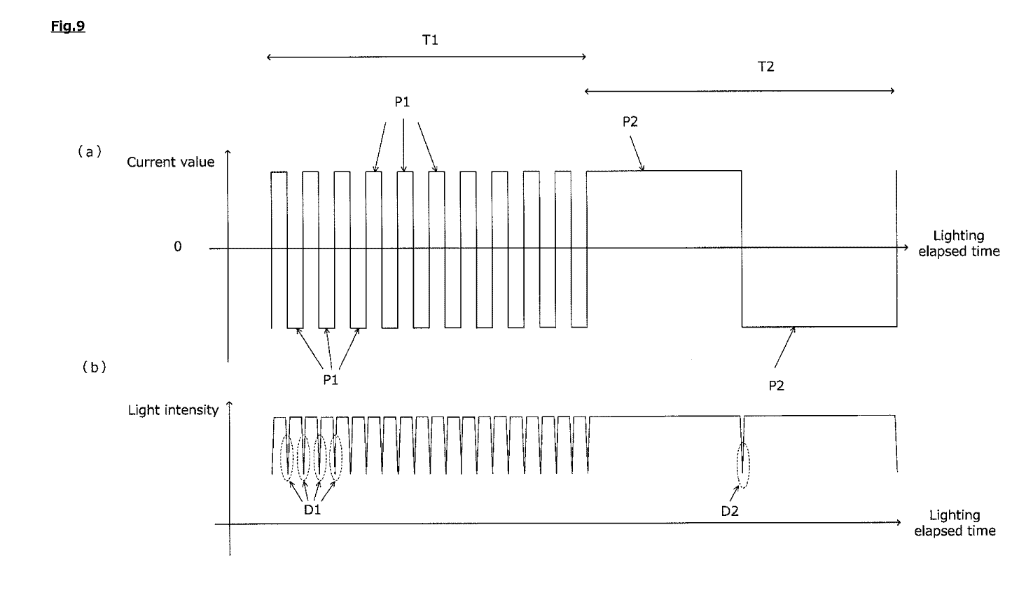

A description will be given of the pulse wave P generated from the pulse generating section 41 with reference to FIG. 3. FIG. 3 is a view showing a waveform of the pulse signal P output from the pulse generating section 41, that is, an example of a lamp current waveform of the discharge lamp 10. The pulse wave P generated from the pulse generating section 41 repeats a cycle in which a pulse wave P1 (corresponding to “first pulse wave”) with a fundamental frequency f1 is output for a predetermined period T1, and thereafter a pulse wave P2 (corresponding to “second pulse wave”) with a frequency f2 which is lower than the fundamental frequency is output for a predetermined period T2 which is shorter than the predetermined period T1. This point is common with the contents mentioned above with reference to FIG. 8. In FIGS. 3 and 8, the lengths of the period T1 and the period T2 are not greatly different for convenience of explanation; however, the length of the period T1 may be actually set to be sufficiently longer than the length of the period T2.

However, in the present embodiment, the crest value of the pulse wave P2 is set to be ΔP lower than the pulse wave P1. More specifically, a value of the control power value designated to the power supply section 3 from the power control section 42 is differentiated between the period T1 (corresponding to “first period”) and the period T2 (corresponding to “second period”). In this example, the gate signal Gx is supplied to the switching element Qx from the power control section 42 so that a power value at the period T2 is lower than a power value at the period T1. In more detail, the power to be supplied to the discharge lamp 10 at the period T2 is lowered in comparison with that at the period T1 by lowering the duty ratio of the gate signal Gx at the period T2 in comparison with that at the period T1.

The power control section 42 appropriately changes the duty ratio of the gate signal Gx on the basis of a value of an electric current flowing in the resistance Rx of the power supply section 3 and a value of an electric voltage indicated by the voltage dividing resistance Vx, and carries out a feedback control for maintaining the input power at a target power value (the control power value). Further, when a signal relating to a timing for switching the period T1 and the period T2 is given in the control section 4, the power control section 42 changes the control power value on the basis of the signal. Further, the power control section 42 changes the duty ratio of the gate signal Gx so as to make the power value input by the feedback control coincide with the set control power value. The information relating to the control power value at the period T1 and the period T2 may be set to the information previously stored by the power control section 42. At this time, the information relating to the control value itself at each of the periods T1 and T2 may be stored, or the information relating to the rate of the control value between one period and the other period may be stored.

The frequency control section 43 outputs the information relating to the frequency of the pulse wave P at a predetermined timing to the pulse generating section 41 so that the pulse wave P exhibits such a frequency fluctuation as shown in FIG. 3. For example, the frequency control section 43 can be provided with a timer which measures an elapsed time after starting the output of the pulse wave P, and a memory which stores a frequency f1 of the pulse wave P1, the information relating to a continuous output time T1 of the pulse wave P1, a frequency f2 of the pulse wave P2 and a continuous output time T2 of the pulse wave P2. At this time, the frequency decision section 43 decides the frequency of the pulse wave P on the basis of the information relating to the elapsed time given from the timer, and the information stored in the memory, and outputs the decided frequency to the pulse generating section 41. The pulse generating section 41 outputs the pulse wave P with the frequency which is decided on the basis of the control signal from the frequency control section 43 to the power supply section 3.

For example, the frequency decision section 43 first of all sets so that the pulse wave with the frequency f1 is output to the pulse generating section 41 at the pulse generation starting time. Next, when the elapse of the time T1 is detected by the timer, the frequency decision section 43 reads the information relating to the frequency f2 of the pulse wave P2 from the memory, and sets so as to output the pulse wave with the frequency f2. Further, when the elapse of the time T2 is detected by the timer, the frequency decision section 43 reads the information relating to the frequency f1 of the pulse wave P1 from the memory and again sets so as to output the pulse wave with the frequency f1. The frequency control section 43 repeats the control mentioned above thereafter.

In the case where the frequency decision section 43 is provided with the timer as mentioned above, a signal relating to a timing for switching the period T1 and the period T2 may be output to the power control section 42 at a timing of outputting a signal for changing the frequency to the pulse generating section 41.

The frequency (the fundamental frequency) of the pulse wave P1 corresponds to a fundamental frequency when the discharge lamp 10 is lighted in a steady state, and is a frequency which is selected from a range, for example, from 60 to 1000 Hz. Further, the pulse wave P2 is a low frequency which is intermittently inserted after the elapse of the period T1, and the frequency is a frequency which is lower than the fundamental frequency and is selected from a range, for example, from 5 to 200 Hz.

The pulse wave P2 is preferably inserted at a time interval which is equal to or longer than 0.01 seconds and equal to or shorter than 120 seconds. In other words, it is preferable to set the period T1 to a range which is equal to or longer than 0.01 seconds and equal to or shorter than 120 seconds, and it is more preferable to set the period T1 to a range which is equal to or shorter than 0.01 seconds and equal to or shorter than 2 seconds. If the pulse wave P2 is inserted to a time interval which is shorter than 0.01 seconds, the projection 21 forming a starting point of an arc is heated too much, and there is a risk that a shape of the projection 21 is deformed or may be eliminated in some cases. On the contrary, if the time interval is set to be too longer, a state in which the micro projection is kept formed at a peripheral position of the projection 21 is maintained long, and there is a risk that the arc starting from the micro projection is formed during this time.

In the example in FIG. 3, the period T2 at which the pulse wave P2 is output is set to the period of one cycle of the pulse wave P2. In other words, the pulse generating section 41 is structured to output the pulse wave P2 with the positive polarity or the negative polarity one by one within the period T2. However, the output mode of the pulse wave P2 is not limited to the mode mentioned above.

For example, it is possible to employ a structure in which the pulse generating section 41 outputs the pulse wave P1 for the predetermined period T1, thereafter outputs the pulse wave P2 with the low frequency for a half cycle length T2, further outputs the pulse wave P1 for the time T1 and thereafter outputs the pulse wave P2 for a half cycle length T2 while changing the polarity from the previous one. Further, the pulse wave P2 with the low frequency included in the pulse signal output from the pulse generating section 41 may be structured to be included over one cycle or more time, for example, 1.5 cycles of the pulse wave P2. If the time for applying the pulse wave P2 with the low frequency is elongated too long, and there is a risk that the electrode is heated too much and the shape of the projection 21 forming the arc starting point changes. As a result, within one cycle, the pulse wave P2 with the low frequency is preferably kept in one cycle.

### Operation

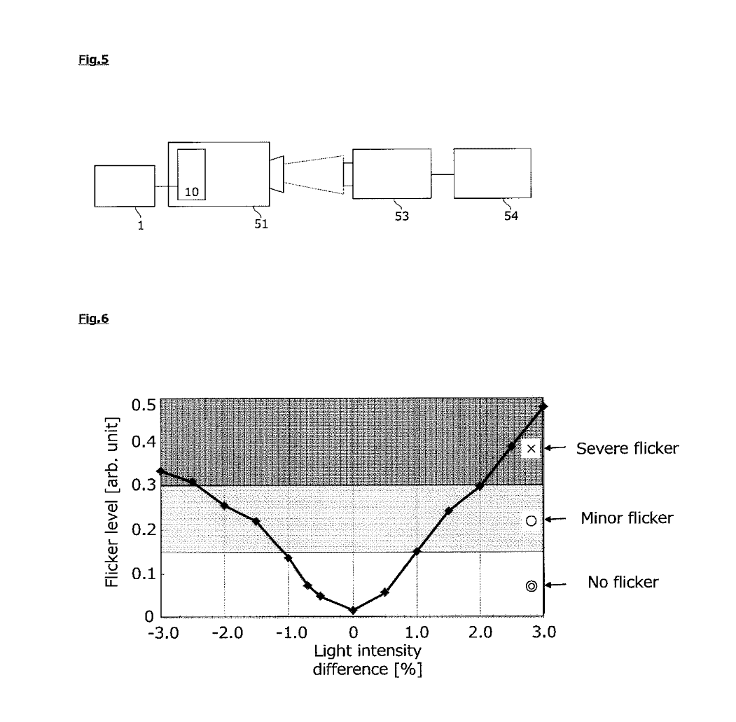

FIG. 4 is a graph showing a variation of a light intensity of the projected light in conformity to the waveform of the lamp current shown in FIG. 3. In FIG. 4, (a) is a waveform of the same lamp current as FIG. 3, and (b) is a waveform showing the variation of the light intensity of the projected light.

As mentioned above with reference to FIG. 3, the lighting apparatus 1 according to the present embodiment is set so that an input power from the power supply section 3 to the discharge lamp 10 is lower at the period T2 than at the period T1, on the basis of the control from the power control section 42. As a result, as shown in (b) in FIG. 4, a steady state value W2 of the light intensity at the period T2 is lower, by ΔW, than a steady state value W1 of the light intensity at the period T1.

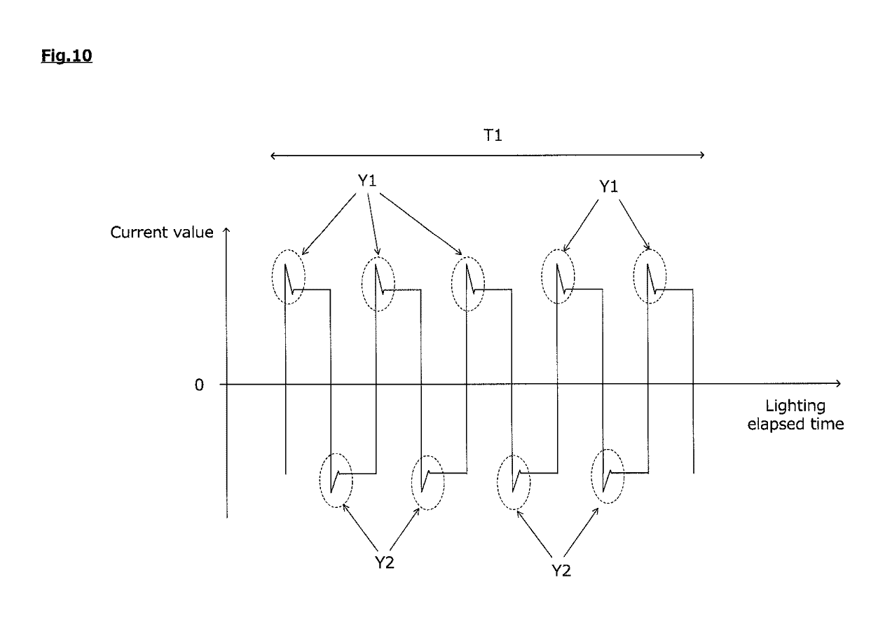

As mentioned above with reference to FIG. 9 in the item of “Problem to be Solved by the Invention”, since the frequency of the polarity reversion is higher at the period T1 than at the period T2, the generating frequency of the dip D1 is high. As a result, in the state shown in FIG. 9, the average light intensity at the period T1 has been lowered in comparison with the average light intensity at the period T2, thereby causing the flicker. On the contrary, according to the structure of the present invention, since the value of the steady state light intensity W2 at the period T2 is previously set to be lower than the value of the steady state light intensity W1 at the period T1, it is possible to reduce a difference between the average light intensity over the period T1 and the average light intensity over the period T2. As a result, the light is viewed as the light having approximately the same output over both period T1 and the period T2, and the flicker is hard to be viewed.

### Setting Method in Power Control Section 42

As mentioned above, the power control section 42 is structured to previously store the control power value at each of the periods T1 and T2. A description will be given below of an example of a method of setting the control power value mentioned above. The setting of the control power value may be carried out in a stage before shipping the lighting apparatus 1 and the discharge lamp 10.

FIG. 5 is a schematic view describing a method of setting the control power value. The light from the projection device 51 including the discharge lamp 10 and an optical system is applied toward the light detection section 53 including a highly-sensitive sensor, and the time variation of the light intensity detected by the light detection section 53 is confirmed by an oscilloscope 54. At this time, the lighting apparatus 1 first of all supplies the electric current to the discharge lamp 10 in a state in which the control power value is fixed, at the period T1 and the period T2. The oscilloscope 54 calculates the average light intensity at each of the periods T1 and T2 as well as acquiring a variation mode of the light intensity under this state.

Further, the same process as mentioned above is carried out while the input power is changed to the discharge lamp 10 from the lighting apparatus 1 at any one or both of the period T1 and T2, and a condition that the difference between the average light intensities is within a predetermined threshold value is to be found. Further, a value of the input power when the condition is established is stored in the power control section 42.

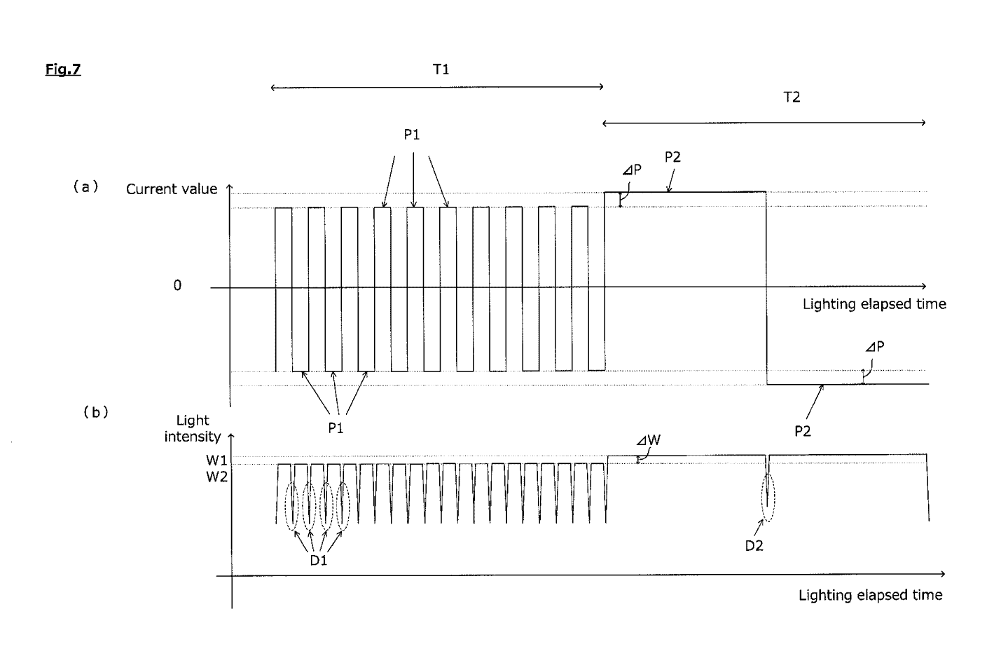

Here, the “predetermined threshold value” mentioned above is preferably set to ±2%, and further preferably set to ±1%. FIG. 6 is a graph showing a relationship between the light intensity difference and the flicker level. Here, a main horizontal axis (a lower horizontal axis) indicates the light intensity difference, which is a value calculated by the following (Mathematical expression 1).

Light intensity difference=(average light intensity at period T2−average light intensity at period T1)/average light intensity at period T1 (Mathematical expression 1)

Further, a vertical axis indicates the flicker level, which is obtained by digitalizing a flickering degree of a screen at a human visible frequency. Here, “minor flicker” indicates a level at which a flicker may be viewed in some viewing person or environment, and “severe flicker” indicates a level at which a flicker is viewed regardless of the viewing person or environment. Further, “no flicker” indicates a level at which a flicker is not viewed regardless of the viewing person or environment.

According to FIG. 6, it can be known that if the light intensity difference goes beyond ±2%, a flicker having the level (severe flicker) at which a lot of viewers can view a flicker occurs. On the other hand, a probability at which the flicker is viewed can be lowered by keeping the light intensity difference within ±2%, and a state in which the flicker is not viewed can be completely generated by keeping the light intensity difference within ±1%.

In a stage before shipping, the value of the input power at each of the period by which the difference between the average light intensities at the respective periods T1 and T2 is within ±2% is stored as the control power value at each of the periods in the power control section 42. According to the lighting apparatus 1 in a state in which the above setting is achieved in the power control section 42, the difference between the light intensities at the period T1 when the pulse wave P1 is output and the period T2 when the pulse wave P2 is output is extremely small even if the lighting control is applied to the discharge lamp 10 on the basis of the pulse wave P1 and the pulse wave P2. As a result, the flickering (the flicker) of the light intensity can be suppressed at the position which is lighted by the discharge lamp 10.

### Other Embodiment

A description will be given below of the other embodiment.

<1> In the embodiment mentioned above, the description is given by employing, as an example, the case where the input power is controlled to be lowered at the period T2 at which the pulse wave P2 with the low frequency is output in comparison with the input voltage at the period T1 at which the pulse wave P1 with the high frequency (the fundamental frequency) is output in the power control section 42 (refer to FIG. 4). However, as mentioned above with reference to FIG. 10 in the item “Problem to be Solved by the Invention”, the case where the average light intensity is higher at the period T1 than at the period T2 may occur in the case where the input power is fixed.

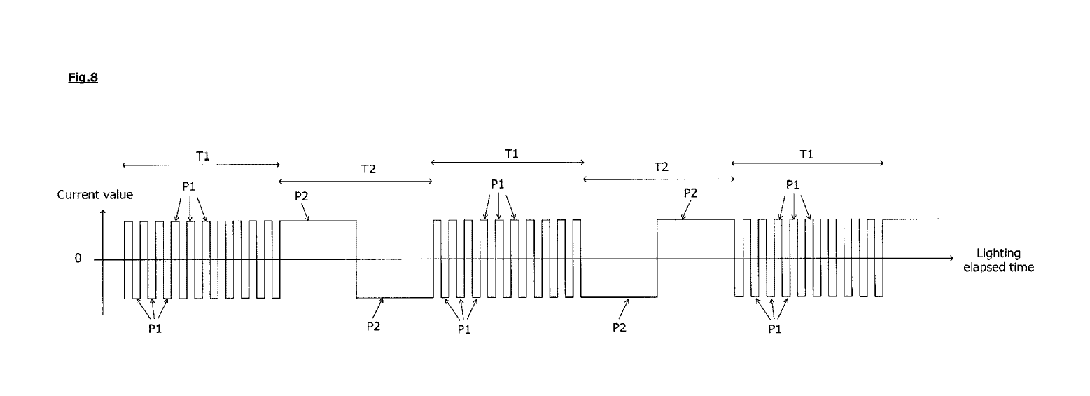

In the case mentioned above, the input power may be controlled to be higher at the period T2 than at the period T1 in the power control section 42 (refer to FIG. 7). FIG. 7 is a view showing the other example of the waveform of the lamp current and the waveform of the light intensity, in which (a) is the waveform of the lamp current and (b) is the waveform indicating the variation of the light intensity of the projected light in the same manner as FIG. 4. In the current waveform shown in FIG. 7, the illustration of the overshoot as shown in FIG. 10 is omitted.

<2> In the embodiment mentioned above, the description is given on the assumption that the control power value at each of the periods T1 and T2 is determined by directly applying the projected light onto the light detection section 53 by the projection device 51 including the discharge lamp 10 and detecting the light intensity by the oscilloscope 54. However, this method is only an example, and any method may be employed as long as the average light intensities at the periods T1 and T2 can be calculated.

For example, it is possible to employ a structure in which the discharge lamp 10 controlled to be lighted by the lighting apparatus 1 is arranged in an inner side of an integrating sphere, the light intensity in a partial region of an outer wall of the integrating sphere is detected by the light detection section 53, and the detection results are output to the oscilloscope 54. A magnitude of the light intensity output from the discharge lamp 10 can be determined by computation with a ratio of an area of the region which can be detected by the light detection section 53, and a surface area of the integrating sphere. The oscilloscope 54 can calculate the average light intensity at each of the periods T1 and T2 by multiplying the light intensity obtained by the light detection section 53 by the ratio.

The means for calculating the average light intensity at each of the periods T1 and T2 on the basis of the information relating to the light intensity detected by the light detection section 53 is not limited to the oscilloscope 54, but any structure may be employed as long as the same function can be realized.

<3> In the embodiment mentioned above, the average light intensities at the periods T1 and T2 are calculated in the state in which the input power is fixed, and the value of the control power value set to the power supply section 3 from the power control section 42 is differentiated between the period T1 and the period T2 so that the difference between the both is within the predetermined threshold value. However, since the waveforms of the light intensity shown in (b) of FIG. 4 and (b) of FIG. 7 approximately coincide with the waveform of the input power to the discharge lamp 10 from the power supply section 3, the average powers at the periods T1 and T2 may be calculated in the state in which the input power is fixed, and the value of the control power value set to the power supply section 3 from the power control section 42 may be differentiated between the period T1 and the period T2 so that the difference between the periods T1 and T2 is within the predetermined threshold value.

As an example of a specific method, a current value and a voltage value to be supplied from the power supply section 3 to the discharge lamp 10 are measured, a variation of a power value obtained by multiplying the current value and the voltage value is acquired at each of the periods T1 and T2, and respective average values are calculated. Further, the same process as mentioned above is carried out while the input power to the discharge lamp 10 is changed from the lighting apparatus 1 at any one or both of the periods T1 and T2, thereby finding a condition that the difference between both the average powers is within the predetermined threshold value. Further, the value of the input power when the condition mentioned above establishes is stored as the control power value at each of the periods T1 and T2 in the power control section 42. The input power set on the basis of the control power value set according to the method is supplied to the discharge lamp 10 at each of the periods T1 and T2, so that the difference between the average light intensities at the periods T1 and T2 is reduced, and the flicker is suppressed.

<4> In the embodiment mentioned above, the description is given on the assumption that the timing at which the pulse wave P1 is changed to the pulse wave P2 after being continuously output is fixed; however, the timing at which the pulse wave P1 is switched to the pulse wave P2 may be appropriately changed. Further, in the case where the timing at which the pulse wave P2 is inserted is fixed, the pulse wave P1 of about 1 cycle to 2 cycles may be exceptionally inserted at the timing at which the pulse wave P2 is inserted. This is proposed, for example, for the following purpose.

As shown in FIG. 2, in the case where the AC/DC section 32 is the full bridge inverter circuit, the power source for driving the high-side switches Q1 and Q4 is necessary. The power source can employ, for example, a bootstrap circuit, and a capacitor for bootstrap (not shown) is charged when the high-side switches Q1 and Q4 are OFF. If a charged amount of the capacitor is insufficient, the switches Q1 and Q4 cannot be driven ON due to the insufficiency of the power voltage. As a result, the pulse wave P1 of about 1 cycle to 2 cycles may be structured to be exceptionally inserted for the purpose of charging the capacitor.

The other purpose relates to the case where the light source including the lighting apparatus according to the present invention is employed, for example, in a DLP (trademark) type of projector. In the DLP type of projector, a control of reversing a polarity in correspondence to a motion of a color wheel is generally carried out so that a reflected image is not adversely affected, and the capacitor is charged at the polarity reversing time. In the same reason as mentioned above, the pulse wave P1 of about 1 cycle to 2 cycles may be structured to be exceptionally inserted into the output of the pulse wave P2 for the purpose of charging the capacitor in the case where the elapsed time from the starting of the lighting is long and the charging amount to the capacitor is insufficient.

### DESCRIPTION OF REFERENCE SIGNS

1: lighting apparatus
3: power supply section
4: control section
10: discharge lamp
11: light emitting section
12: sealing section
13: metal foil
14: outer lead
20a, 20b: electrode
21: projection
22: discharge arc
23: micro projection
29a, 29b: head section of electrode
30a, 30b: shaft section of electrode
31: step-down chopper section
32: DC/AC conversion section
33: starter section
35: driver
41: pulse generating section
42: power control section
43: frequency control section
51: projection device
53: light detection section
54: oscilloscope

1. A lighting apparatus of a discharge lamp comprising:
a power supply section which supplies AC current to the discharge lamp in which a pair of electrodes are arranged so as to face each other within a discharge vessel in which predetermined gas is encapsulated;
a power control section which outputs a signal concerning a control power value to the power supply section; and
a pulse generating section which outputs a pulse wave to the power supply section, wherein
the power supply section is structured to convert supplied DC voltage into AC current in response to a frequency of the pulse wave and the control power value so as to supply the converted AC current to the discharge lamp,
the pulse generation section is structured to repeat a cycle of outputting a first pulse wave over a first period and thereafter outputting a second pulse wave having a frequency lower than the first pulse wave over a second period shorter than the first period, and
the power control section carries out a control of differentiating the control power value at the first period and the control power value at the second period, in a direction that a difference is reduced between an average light intensity of the discharge lamp at the first period and an average light intensity of the discharge lamp at the second period, or a direction that a difference is reduced between an average power supplied to the discharge lamp at the first period and an average power supplied to the discharge lamp at the second period, in comparison with a case where the control power value is identical at the first period and the second period.

2. The lighting apparatus of the discharge lamp according to claim 1, wherein the power control section is structured to perform control to differentiate the control power value at the first period and the control power value at the second period, so that the difference between the average light intensity of the discharge lamp at the first period and the average light intensity of the discharge lamp at the second period is within a range of ±2%, or the difference between the average power supplied to the discharge lamp at the first period and the average power supplied to the discharge lamp at the second period is within a range of ±2%, in comparison with a case where the same control power value is set in both of the first period and the second period.

3. The lighting apparatus of the discharge lamp according to claim 1, wherein the power control section is structured to previously store information concerning a ratio between the control power value at the first period and the control power value at the second period and to perform control to differentiate the control power value at the first period and the control power value at the second period, on the basis of the stored information.

4. The lighting apparatus of the discharge lamp according to claim 2, wherein the power control section is structured to previously store information concerning a ratio between the control power value at the first period and the control power value at the second period and to perform control to differentiate the control power value at the first period and the control power value at the second period, on the basis of the stored information.
